(19) United States
(12) Patent Application Publication
(10) Pub. No.: US 2015/0346863 A1
(43) Pub. Date: Dec. 3, 2015

(54) TOUCH PANEL AND ELECTRONIC DEVICE WITH TOUCH PANEL

(71) Applicant: KABUSHIKI KAISHA TOSHIBA, Tokyo (JP)

(72) Inventor: Hirofumi Morita, Higashiyamato Tokyo (JP)

(21) Appl. No.: 14/569,473

(22) Filed: Dec. 12, 2014

Related U.S. Application Data
(60) Provisional application No. 62/004,419, filed on May 29, 2014.

(51) Int. Cl. G06F 3/044

(52) U.S. Cl. CPC G06F 3/044

(57) ABSTRACT

According to one embodiment, provided is an electronic device including an image display portion and a touch panel, the touch panel including a transparent sensor board of an insulating material with first and second surfaces, a polygonal detection area on the sensor board to be overlaid on the image display portion, including a sensor pattern, and inputting location data in the image display portion, a trace area outside the detection area and along respective sides of the polygon in which signal lines connected to the respective electrodes are arranged, and output portions along one side of the detection area, guiding the signal lines in the direction away from the detection area, and outputting to the electronic device the location data.

### CROSS-REFERENCE TO RELATED APPLICATIONS

This application claims the benefit of U.S. Provisional Application No. 62/004,419, filed May 29, 2014, the entire contents of which are incorporated herein by reference.

### FIELD

Embodiments described herein relate generally to a touch panel and electronic device with a touch panel.

### BACKGROUND

For example, there are some cases where a connection area configured to connect to a flexible substrate is formed in a trace area along each of two sides of a detection area of a touch panel on the outside thereof, and these trace areas are bent in such a manner as to be arranged along the outer side surface of the display panel.

In such a touch panel, there is a demand to reduce the width of the frame as much as possible and to create a blank space area in the trace area adjacent to the detection area so as to provide various members therein.

According to one embodiment, there is provided a touch panel for an electronic device comprising an image display portion. The touch panel comprises a transparent sensor board of an insulating material with a first surface and a second surface; a polygonal detection area on the sensor board overlaid on an image display portion, comprising a sensor pattern of a plurality of transparent electrodes, the detection area configured to input location data in the image display portion; a trace area on the outside of the detection area, along each sides of the polygon, in which a plurality of signal lines connected to the respective electrodes are extendedly arranged; and at least two data output portions along one side of the detection area, guiding the plurality of signal lines in the trace area in the direction away from the detection area, and configured to output the location data transmitted via the plurality of signal lines.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an elevation view of an electronic device comprising a touch panel of an embodiment.

FIG. 2 is an explanatory drawing of a display portion of the electronic device viewed from behind.

FIG. 3 is an enlarged view of a part of FIG. 2.

FIG. 4 is a drawing of the touch panel viewed from behind.

FIG. 5 is an explanatory drawing of a relationship between an electrode pattern and a signal line of the touch panel.

FIG. 6 is an explanatory drawing of arrangement of a signal line of the touch panel.

FIG. 7 is an explanatory drawing of an output portion of a signal line of the touch panel.

FIG. 8 is an explanatory drawing of one example of a laminated structure in the touch panel.

FIG. 9 is an explanatory drawing of another example of the laminated structure in the touch panel.

FIG. 10 is an explanatory drawing of a computer comprising the touch panel.

FIG. 11 is an explanatory drawing of a smartphone comprising the touch panel.

FIG. 12 is an explanatory drawing of a digitizer comprising the touch panel.

### DETAILED DESCRIPTION

Various embodiments will be described hereinafter with reference to the accompanying drawings. In the drawings, portions similar to each other are denoted by the same reference numbers.

As shown in FIGS. 1 to 3, an electronic device 10 of an embodiment is realized as a tablet computer having a horizontally long rectangle shape as a whole. This electronic device 10 comprises a housing 16 comprising a display unit 12 provided on the user's side, namely, on the front side, and a cabinet portion 14 supporting the display unit 12 from behind, and an internal space is created in the housing 16. In the internal space, various necessary circuit boards and electronic members such as a control board, a power circuit board, and a circuit board for driving a speaker are provided, the control board connected to a liquid crystal panel 18 and a touch panel 20 of the display unit 12, which will be described later, and configured to control the whole electronic device 10.

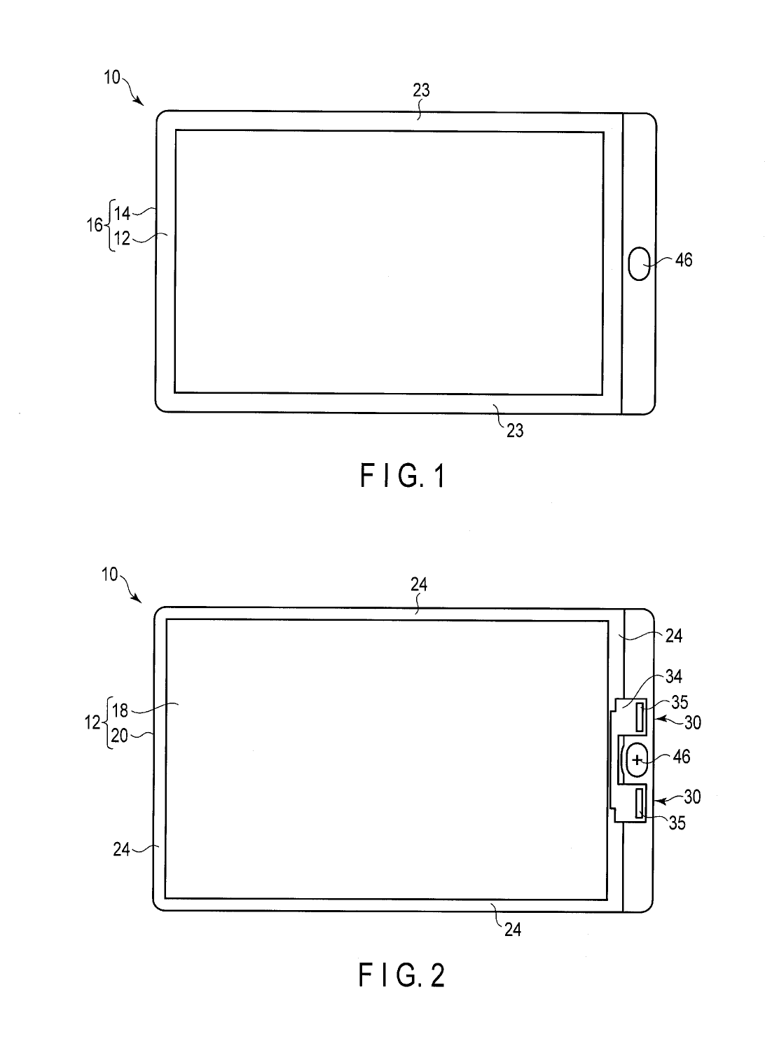

As schematically shown in FIGS. 2 to 4, the display unit 12 comprises a liquid crystal panel 18 and a touch panel 20 overlaid on the front surface side of the liquid crystal panel 18. The liquid crystal panel 18 provides an image display portion having a polygonal shape, preferably, a horizontally long rectangular shape comprising two short side portions and two long side portions. The image display portion, namely, the liquid crystal panel 18 is configured to receive an image signal from an image signal processing circuit of a control circuit (neither shown) comprising an electronic component and the like mounted on a board in the internal space to display an image such as a still image, a moving image and the like.

The touch panel 20 comprises a detection area 22 having a shape similar to that of the liquid crystal panel 18 and overlaid on the liquid crystal panel 18, and a trace area 24 provided outside of the detection area 22 along the periphery of the detection area 22 and formed in a band shape. The trace area 24 is located in a peripheral area when viewed from the front side of the display unit 12 (see FIG. 1), the peripheral area colored, for example, black and forming a frame 23 of a sensor substrate 36 made of an insulating material, which will be described later. Therefore, the trace area is not visually recognizable from outside.

The light for showing an image displayed on the front surface of the liquid crystal panel 18 is emitted forward through the detection area 22 of the touch panel 20. The user can recognize an image or video displayed on the liquid crystal panel 18 through the detection area 22, the image or video formed of the light transmitted there through.

In the touch panel 20, a specific location in an image displayed on the liquid crystal panel 18 and recognized via the detection area 22 is detected with a sensor pattern arranged in the detection area 22 when the location is touched with a finger, a stylus, etc. Location data (coordinate data) indicative of the touched location in the touch panel 20 is transmitted to the above-mentioned control unit via the trace area 24 to execute processing therein based on the signal. The touch panel 20 functions as one of the input devices of the electronic device 10.

The touch panel 20 can employ a sensor pattern of an appropriate method. For example, it may be a capacitive method in which, with two electrode layers laminated via an insulating layer there between, a touch location is detected based on capacitance change (electric charge) caused between the electrodes when the electrodes come close to or into contact with each other in the location touched with a finger, a stylus, etc.

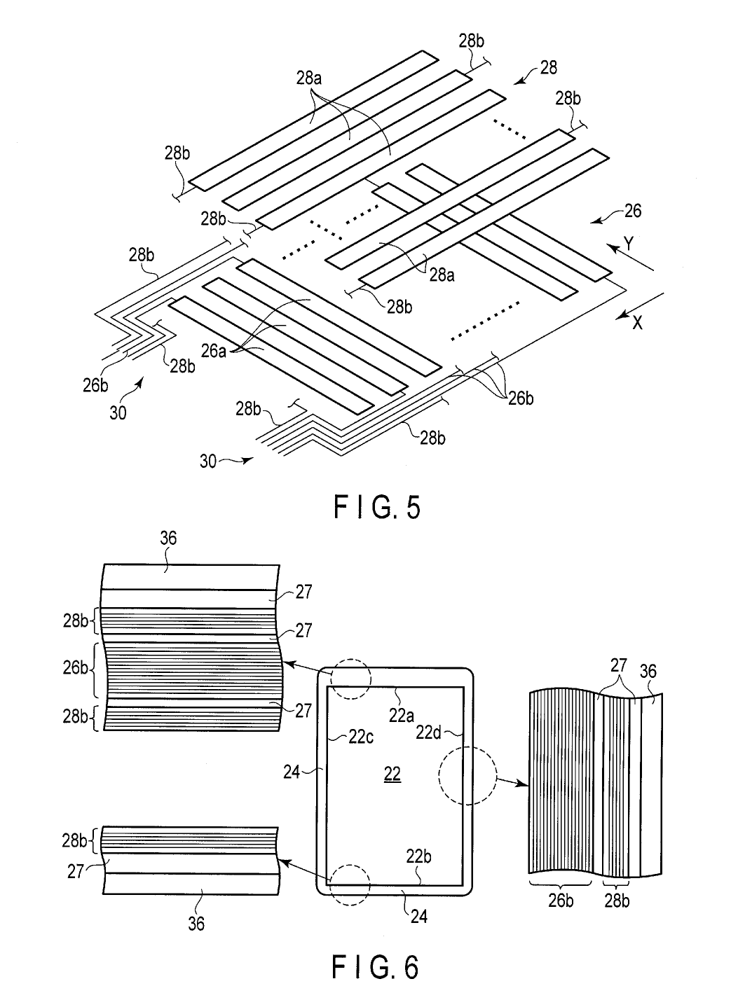

In the case of such a capacitive method, as illustrated in FIG. 5 as an example, the detection area 22 comprises an x-direction electrode layer 26 in which a plurality of electrodes 26a extending in the x-direction are arranged, and a y-direction electrode layer 28 in which a plurality of transparent electrodes 28a extending in a y-direction across (preferably, perpendicular to) the x-direction are arranged, and a dielectric layer is provided between these electrode layers 26 and 28. Further, signal lines 26b and 28b extend from respective electrodes 26a and 28a. By arranging these transparent electrodes 26a and 28a, a sensor pattern is formed. Note that the sensor pattern of electrodes 26a and 28a shown in the drawing is illustrated for the purpose of explanation only, and therefore it is certainly possible to adopt a sensor pattern of an appropriate electrode pattern as may be necessary.

For example, it may be a resistive film method in which, with two transparent conductive films bonded together (not shown), a location touched with a finger, a stylus, or the like is detected as the conductive films are connected at the touched location.

In any cases, the number of signal lines 26b and 28b connected to the respective electrodes 26a and 28a in the detection area 22 increases as the area of the detection area 22 increases. These signal lines 26b and 28b are arranged in the trace area 24 with such a small gap there between. Therefore, as the number of the signal lines in the trace area 24 increases, the width of the band-shaped trace area 24 increases.

As shown in FIG. 6, in the present embodiment, all signal lines 26b and 28b are lead to one short side portions 22a of the four side portions 22a, 22b, 22c and 22d defining the detection area 22, and data output portions 30 are provided to connect to an external circuit from this short side portion 22a.

In the trace area 24 of the short side portion 22b opposite to the short side portion 22a, for example, ten signal lines 28b extending from the short side portion 22b are provided. For example, forty signal lines 26b extending from two long side portions 22c and 22d are provided in the trace area 24 along the long side portions 22c and 22d, respectively. In one or both of the long side portions 22c and 22d, a ground is provided between signal lines 26b and 28b extending from two different electrode layers 26 and 28, and each trace area 24 is provided with a ground 27 on the inner side of the outer edge with a gap of, for example, 2.5 mm, necessary for etching processing or the like to form electrode layers 26 and 28 and the trace area 24, thereby preventing an influence of an effect of external noise.

In this way, it is possible to make the widths of the trace areas along the long side portions 22c and 22d substantially the same as each other and to reduce the width of the trace areas as a whole as much as possible. The touch panel 20 achieves the reduction of the size of the frame while a large number of signal lines 26b and 28b are provided in the trace area 24.

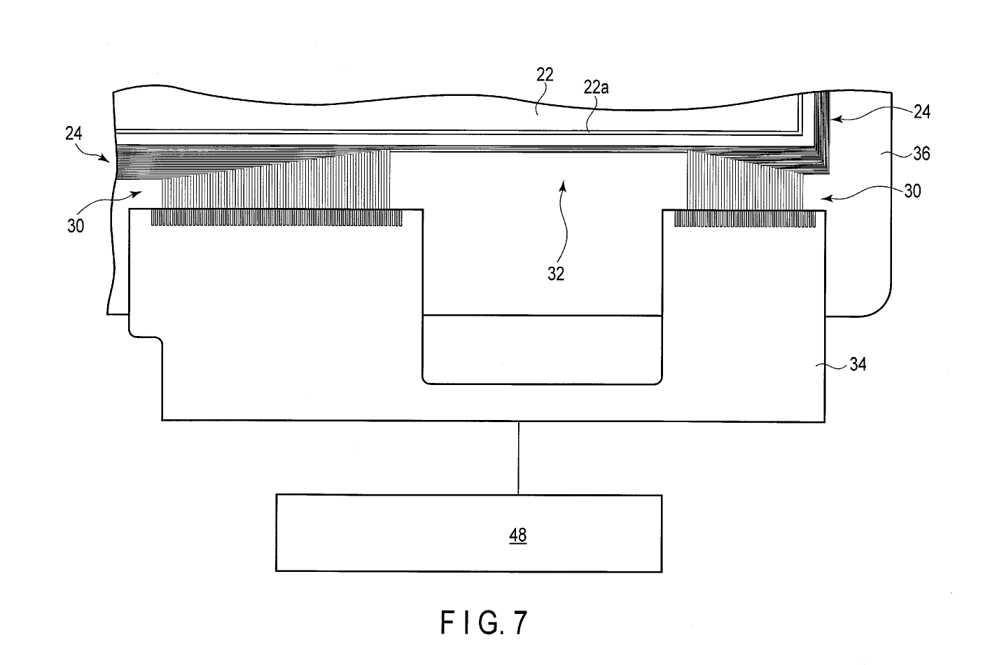

As shown in FIG. 4, these signal lines 26b and 28b are arranged in the trace area 24 formed on the outer peripheral side of the detection area 22 and routed up to the short side portion 22a. Signal lines 26b and 28b in the trace area 24 are terminated in the data output portion 30 provided in one short side portion 22a of the touch panel 20. From the data output portion 30, location data input to the detection area and transmitted via the plurality of signal lines 26b and 28b can be output to a control circuit 48 of the electronic device 10 (FIG. 7). In the present embodiment, there are two data output portions 30 provided in one short side portion 22a in which signal lines 26b and 28b are most densely provided, but more than two data output portions 30 may be provided as long as they are provided in the same side portion.

As shown in FIG. 7, in the data output portion 30, the signal lines in the trace area 24 are formed into an output pattern in which the signal lines extend in the direction away from the detection area 22 and the leading ends of the respective signal lines are arranged linearly. In each data output portion 30, signal lines extending from adjacent side portions and arranged in the trace area 24 are guided in a manner as to be bent in the direction away from the detection area 22. Therefore, between data output portions 30 and 30 adjacent to each other, an blank space area 32 accommodating no signal lines therein except some of signal lines 28b extending from the side portion 22a is created. If there is only a single data output portion 30, the blank space area 32 forms a part of the trace area 24 in which the signal lines 26b and 28b and the ground 27 are arranged. Therefore, the blank space area 32 is substantially a cut out part of the band-shaped trace area 24.

In the data output portion 30 formed in this way, each signal line is arranged substantially perpendicular to the trace region 24 of the side portion 22a. A flexible circuit board 34 comprising a trace pattern corresponding to the signal lines of the data output portion 30 is bonded to the data output portion 30 by thermal compression. The location data detected by the detection circuit 22 is transmitted to the control circuit 48 of the electronic device 10 via the flexible circuit board 34.

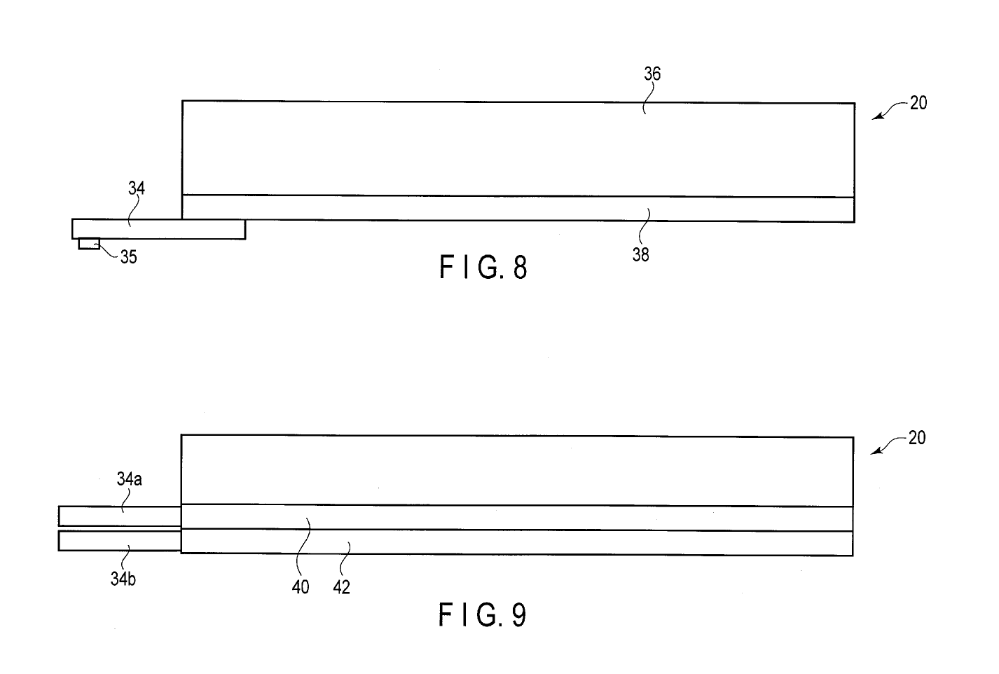

When the touch panel 20 comprises, as shown in FIG. 8, a sensor board 36 made of a transmissive, preferably colorless and transparent, glass plate with a thickness of about 0.55 to 0.7 mm, and an in indium tin oxide film (ITO) pattern 38 formed directly on one side surface of the sensor board 36, for example, by screen-printing the electrode layers 26 and 28 and the trace area 24, the ITO pattern 38 is bonded to the flexible circuit board 34 by thermal compression, and signal lines 26b and 28b are connected to necessary trace portions of the flexible circuit board 34 with solder. Further, as shown in FIG. 9, the electrode pattern of the x-direction electrode 26 and the electrode pattern of the y-direction electrode 28 may be formed with the trace area 24 on an ITO film 40 and on an ITO film 42, respectively, and these ITO films 40 and 42 may be bonded to the sensor board 36 with a conductive adhesive. When such ITO films 40 and 42 are used, it is possible to form flexible circuit boards 34a and 34b and data output portions 30 of the transparent electrode films 40 and 42 as a unit, respectively.

Such flexible circuit boards 34, 34a and 34b may be in any shape as long as they can transmit location data transmitted from the data output portion 30 to the control circuit 48 of the electronic device 10 via signal lines 26b and 28b. Such a connector 35 as shown in FIGS. 2 to 4 may be mounted on these flexible circuit boards 34, 34a and 34b. In any case, it is preferable to form them into such a shape as to be arranged without overlapping with or covering the above-mentioned blank space area 32 so as to detour the blank space area 32.

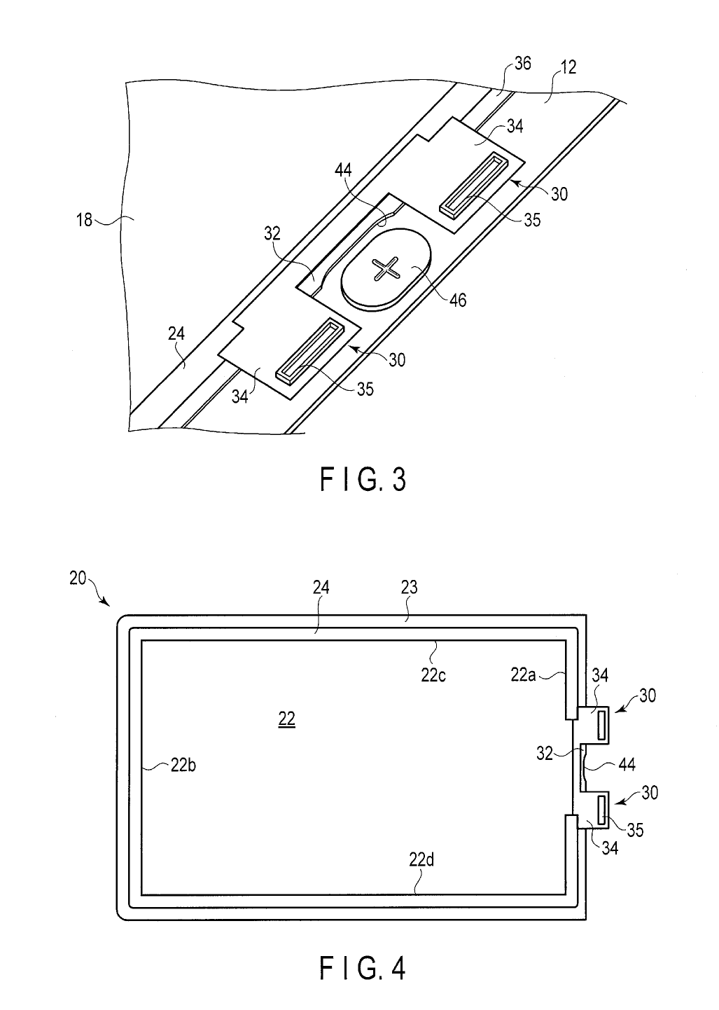

As shown in FIGS. 3 and 4, the touch panel 20 formed in this way comprises a notch 44 provided in the blank area 32 of the sensor substrate 36 and opening in both front and back surfaces of the sensor board 36. In the data output portions 30 and 30 sandwiching the blank space area 32, signal lines 26b and 28b extending at least from adjacent long side portions 22c and 22d and a short side portion 22b on the opposite side are guided in a manner as to be bent in the direction away from the detection area 22. In the portion of the blank space area 32 adjacent to the detection area 22, only some of signal lines 28b extending from the short portion 22a are provided. Therefore, it is possible to form a notch 44 by cutting out the outer edge portion of the sensor board 36 in a wide range from the outer edge portion of the sensor board 36 to the portion adjacent to the detection area 22. Note that the size of the notch 44 can be enlarged in the direction along the side portion 22a of the notch 44 by broadening the gap between the data output portions 30 and 30 laying side-by-side.

FIGS. 1 to 3 illustrate an example in which an operation button 46 of the electronic device 10 is provided in such a notch 44. The operation button 46 is located in proximity to the image display portion formed of the liquid crystal panel 18. By the user's manual operation of the operation button 46, it is possible to perform necessary functions of the electronic device 10. Such an operation button 46 can be of an appropriate type based on the functions of the electronic device 10 such as a power button to power on/off or an operation button to operate the operating system of the electronic device 10. Further, as the operation type of the operation button 46, various types such as a push-button type, a slide type and a rocker type can be adopted.

At least a part of the operation button 46 is located in the notch 44 formed in the sensor board 36. It is possible to provide the operation button 46 in a portion in close proximity to the image display portion. In this way, the frame of the electronic device 10 can be reduced in size. By providing the operation button 46 of the electronic device 10 close to the detection area 22, the operability of the electronic device 10 is improved. Such an electronic device 10 as to comprise an image display portion and a detection area 22 the areas of which are large with respect to the contour, be made more compact and be improved in operability is provided.

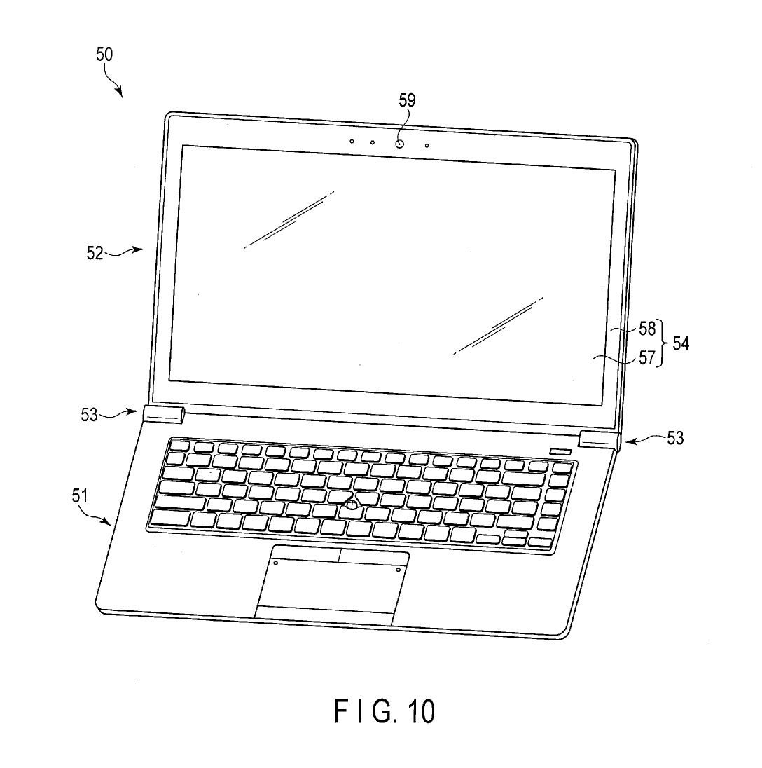

FIG. 10 illustrates an electronic device 50 realized as a so-called notebook computer.

The electronic device 50 comprises a rectangle and flat first body portion 51 and a rectangle and flat second body portion 52. These first body portion 51 and second body portion 52 are connected by a hinge mechanism 53 in such a manner as to be relatively rotatable between an unfolded state as shown in FIG. 10 and a folded state where the first body portion 51 and the second body portion 52 are folded up.

In the second body portion 52, there are a display unit 54 provided with a liquid crystal panel such as an LCD with a touch panel provided on the surface thereof and a cabinet portion 56 supporting the display unit 54 from behind. The structure of the display unit 54 is similar to that of the above-mentioned display unit 12, and thus the detailed descriptions thereof will be omitted.

The display unit 54 comprises a detection area 57 overlaid on the liquid crystal panel having a horizontally long rectangle shape as a whole, and a frame 58 provided with a band-shaped trace area along the periphery of the detection area 57.

In this present embodiment, a blank space area similar to the above-described blank space area 32 is formed in the upper long side portion, and a notch similar to the above-mentioned notch 44 is also formed in this blank space area 32. A camera lens 59 is then provided in the blank space area, and at least a part of the camera lens 59 is located in the notch. Data output portions are provided on both sides of the camera lens 59. It is certainly possible to provide such an operation switch as described above instead of or together with the camera lens 59.

Also in this embodiment, a blank space area is formed in such a manner as to cut off the trace area. By providing the camera lens 59 therein, the size of the frame can be reduced in the portion in which the camera lens 59 is provided.

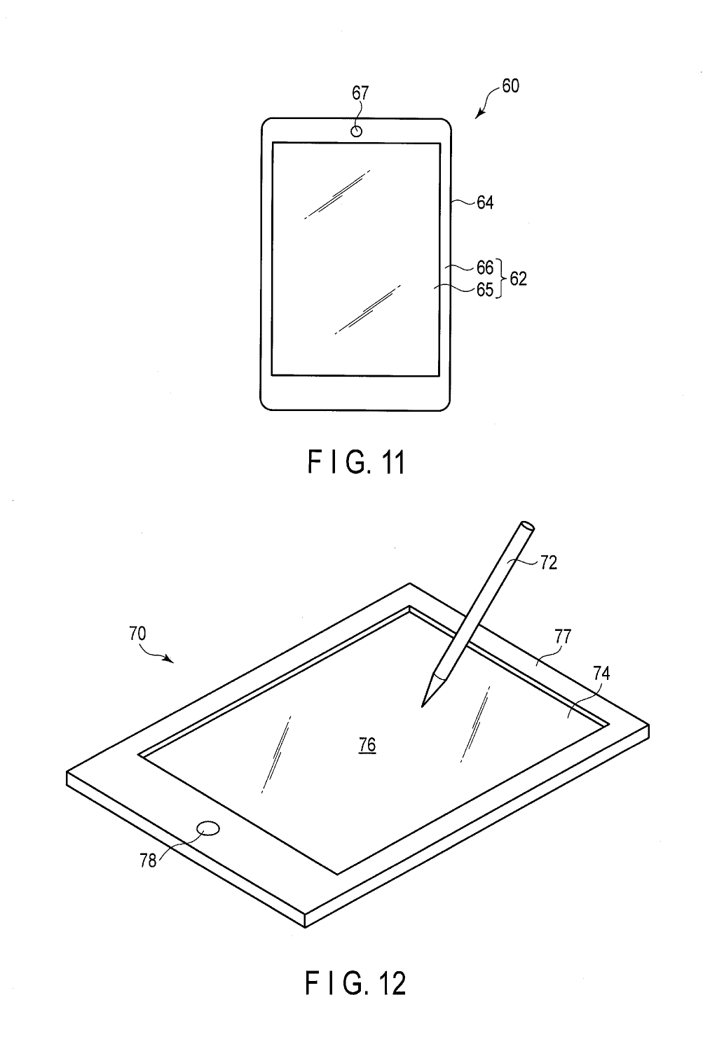

FIG. 11 illustrates an electronic device 60 realized as a smartphone.

In the electronic device 60, a housing is formed of a display unit 62 provided on the user's side, namely, on the front side, and a cabinet portion 64 supporting the display unit 62 from behind. The display unit 62 has a structure similar to that of the above-mentioned display unit 12, and therefore the detailed description thereof will be omitted.

The display unit 62 comprises a detection area 65 formed in a vertically long rectangle shape as a whole to be overlaid on a liquid crystal panel, and a frame or trace area 66 formed in a band-shape along the periphery of the detection area 65.

In the electronic device 60, a blank space area similar to the above-mentioned blank space area 32 is formed in the upper short side portion, and this blank space area 32 is provided with a notch similar to the above-mentioned notch 44 as well. The blank space area is provided with a camera lens 67, and at least a part of the camera lens 67 is located in the notch.

The electronic device 60 is provided with a blank space area in such a manner as to cut out the trace area as well. By providing the camera lens 67 therein, the size of the frame can be reduced in the portion in which the camera lens 67 is provided.

FIG. 12 illustrates an electronic device 70 realized as a digitizer. Such a digitizer can appropriately adopt various detection methods such as a resistive film method and an electromagnetic induction method. In the resistive film method, for example, the user can perform an input operation with a finger. When the electromagnetic induction method is adopted, a stylus pointer 72 is required as an external input means.

When the electromagnetic induction method is adopted, the detection area 76 of the sensor board 74 is provided with, for example, a plurality of loop coils arranged in the x-direction and a plurality of loop coils arranged in the y-direction (neither shown). The stylus pointer 72 is provided with a circuit configured to generate a magnetic field, and the location of the pointer 72 is calculated based on a signal detected by the loop coils adjacent to the pointer 72. The detection location is detected as an absolute location in the detection area 74.

When such a detection area 76 of the sensor board 74 is overlaid on the liquid crystal panel as described above, an electrode, a coil and the like arranged on the sensor board 74 and the detection area are made transparent. However, they are not necessary formed of transparent materials if they are used as input means for inputting coordinate data to a computer or the like. For example, an operation button 78 for a power switch or the like can be provided in an area of the frame 77 along the periphery of the detection area 76

Note that it is certainly possible to combine the various embodiments and modified examples described above with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

10, 50, 60, 70: Electronic device
12: Display unit
14: Cabinet portion
16: Housing
18: Liquid crystal panel
20: Touch panel
22, 57, 65, 76: Detection area
22a, 22b, 22c, 22d: Side portion
24: Trace area
26, 28: Electrode layer
26a, 28a: Electrode
26b, 28b: Signal line
30: Data output portion
32: Blank space area
34, 34a, 34b: Flexible circuit board
35: Connector
38: ITO pattern
40, 42: ITO film
44: Notch
46, 78: Operation button
48: Control circuit
59, 67: Camera lens

What is claimed is:

1. An electronic device comprising an image display portion and a touch panel on the image display, the touch panel comprising:
a transparent sensor board of an insulating material with a first surface and a second surface;
a polygonal detection area on the sensor board overlaid on the image display portion, comprising a sensor pattern of a plurality of transparent electrodes, the detection area configured to input location data in the image display portion;
a trace area on the outside of the detection area, along each side of the polygon, in which a plurality of signal lines connected to the respective electrodes are extendedly wired; and
at least two data output portions along one side of the detection area, guiding the plurality of signal lines in the trace area in a direction away from the detection area, and configured to output the location data transmitted via the plurality of signal lines.

2. The electronic device of claim 1, wherein
the sensor board comprises a blank space area between one of the data output portions and adjacent another data output portion without accommodating any of the signal lines therein, and a notch opening in the blank space area in the first and second surfaces.

3. The electronic device of claim 2, further comprising at least one of an external operation button and a camera, wherein one or both of the external operation button and the camera are provided in the notch.

4. The electronic device of claim 1, wherein
the trace area has a band shape in which the plurality of signal lines are wired extendedly with spaces between the lines, and the trace area adjacent to the side of the data output portions comprises the largest number of signal lines.

5. A touch panel for an electronic device comprising an image display portion, comprising:
a transparent sensor board of an insulating material with a first surface and a second surface;
a polygonal detection area on the sensor board overlaid on the image display portion, comprising a sensor pattern of a plurality of transparent electrodes, the detection area configured to input location data in the image display portion;
a trace area on the outside of the detection area, along each side of the polygon in which a plurality of signal lines connected to the respective electrodes are extendedly wired; and
at least two data output portions along one side of the detection area, guiding the plurality of signal lines in the trace area in a direction away from the detection area, and configured to output the location data, transmitted via the plurality of signal lines.

6. The touch panel of claim 5, wherein
the sensor board comprises a blank space area between one of the data output portions and adjacent another data output portion without accommodating any of the signal lines therein, and a notch opening in the blank space area in the first and second surfaces.

7. The touch panel of claim 5, wherein
the trace area has a band shape in which the plurality of signal lines are extendedly wired with spaces between the lines, and the trace area adjacent to the side of the data output portions comprises the largest number of signal lines.

8. An input device for an electronic apparatus comprising:
an external input member configured to input coordinate data;
a sensor board of an insulating material with a first surface and a second surface;
a polygonal detection area on one of the first and the second surfaces of the sensor board, comprising a sensor pattern of a plurality of electrodes, the detection area configured to input location coordinates by the external input means;
a trace area on the outside of the detection area, along each side of the polygon in which a plurality of signal lines connected to the respective electrodes are extendedly wired; and
at least two data output portions along one of the sides of the detection area, guiding the plurality of signal lines in the trace area in a direction away from the detection area, and configured to output the location coordinates data input, transmitted via the plurality of signal lines.

9. The input device of claim 8, wherein
the sensor board comprises a blank space area between one of the data output portions and adjacent another data output portion without accommodating any of the signal lines therein, and a notch opening in the blank space area in the first and second surfaces.

10. The input device of claim 8, wherein
the trace area has a band shape in which the plurality of signal lines are extendedly wired with spaces between the lines, and the trace area adjacent to the side of the data output portions comprises the largest number of signal lines.
